(19) United States
(12) Patent Application Publication
(10) Pub. No.: US 2025/0103399 A1
(43) Pub. Date: Mar. 27, 2025

(54) SYSTEM AND METHOD FOR PROVISIONING WORKFLOWS

(71) Applicant: JP Morgan Chase Bank, N.A., New York, NY (US)

(72) Inventor: Talluri SUDHEER, Columbus, OH (US)

(73) Assignee: JP Morgan Chase Bank, N.A., New York, NY (US)

(21) Appl. No.: 18/473,986

(22) Filed: Sep. 25, 2023

(51) Int. Cl. G06F 9/50

(52) U.S. Cl. CPC G06F 9/5083

(57) ABSTRACT

Provided are methods and systems for configuring a workflow to create or manage a specified environment. An exemplary method resides as instructions on a non-transitory computer-readable medium and are configured to cause a processor to perform operations including receiving an input including a first set of parameters associated with one or more environments other than the specified environment and a second set of parameters associated with the specified environment. The operations also include generating a payload based on the input, validating the generated payload, and executing, in response to the generated payload being successfully validated, the workflow as an automation-as-a-service workflow using the validated generated payload.

### TECHNICAL FIELD

The present disclosure relates to providing automation services in a workflow management system.

### BACKGROUND

A significant portion of modern computing is conducted in cloud environments which can be broadly defined as computing environments that are enabled by physical and/or virtual devices housed in data centers. From an end user's perspective, an application or a computing environment may be physically and/or logically located in a particular location of data center, but often, such an application can be moved to another location, seamlessly, i.e., without affecting the end user's experience and unknowingly to the end user. As such, migration of applications or even of entire computing environments, is typical in modern computing.

To migrate an application or a computing environment, certain services are used to provision the new location and to configure the application or computing environment to function properly at the new location. When migrated, the application or the computing environment should follow certain criteria, and the most significant one is automation. For example, and not by limitation, migrated applications need to be automatically configured for disaster resiliency and for upgrades, and they need to be configured automatically upon migration. These provisions may be implemented using workflows that adequately achieve the aforementioned configurations. Moreover, these considerations also apply when new applications or computing environments are created, i.e., they also rely on automatic configuration workflows.

In modern computing, as the number of environments or applications to be built or migrated increases, the number of workflows increases. As such, they become hard to maintain and debug, which consumes a significant amount of engineering time, rendering migration or development costly.

### SUMMARY

The embodiments featured herein help solve or mitigate the above noted issues as well as other issues known in the art. The embodiments featured herein utilize automation-as-a-service (AaaS) where automations are deployed as microservices. For instance, in one embodiment, workflows that include microservices that are chained together in a logical alignment including conditional logic and parallel execution. However, because there is no software development life cycle (SDLC) restrictions for these AaaS workflows, production workflows can be changed without implementing SDLC restrictions during development and quality assurance.

Example embodiments are now described, along with several of their benefits. As stated above, in the state-of-the-art, the number of new environments or environments to be moved drastically increases the number of workflows, and these workflows may be redundant because very few parameters change between environments. As such, the embodiments provide parametrized workflows and maintain the state of those parameters for each environment with a single workflow instead of having multiple redundant workflows.

In other words, the embodiments provide a parameter-driven state that maintains the execution (i.e., the state of those parameters and structure of workflows is maintained in global file systems) of AaaS workflows. Furthermore, since parameter files are locked in a global file system and/or in a source code repository, they go through all the scans and other SDLC procedures, thereby providing a solution in which SDLC restrictions are inherently integrated into workflow development and management. The embodiments are thus easy to maintain, they provide faster time to market, they can be changed once and used for multiple environments, and they are low-maintenance. Further, they are easy to debug, e.g., via logs or mails that are generated during workflow generation and/or execution.

In one exemplary embodiment, there is provided a method for configuring a workflow to create or manage a specified environment. The method may be embodied as instructions residing a non-transitory computer-readable medium, and these instructions may be configured to configure a processor to perform certain operations. As configured, the processor embodies an application-specific computing system configured in structure and function to conduct the operations which may include configuring a first set of parameters associated with one or more environments other than the specified environment. The operations may further include configuring set of parameters associated with the specified environment, and they may further include executing an automation service based on the first and second sets of parameters.

In another exemplary embodiment, there is provided a system for configuring a workflow to create or manage a specified environment. The system can include a memory and a processor, which, when executing instructions from the memory, is configured to perform certain operations. The operations may include configuring a first set of parameters associated with one or more environments other than the specified environment, and they may include configuring a second set of parameters associated with the specified environment. The operations may further include executing an automation service based on the first and second sets of parameters.

In yet another exemplary embodiment, there is provided a system for configuring a workflow to create or manage a specified environment. The system includes a memory and a processor, which when executing instructions from the memory, is configured to perform certain operations. The operations can include receiving an input including a first set of parameters associated with one or more environments other than the specified environment and a second set of parameters associated with the specified environment. The operations can further include generating a payload based on the input and validating the generated payload. Furthermore, in response to the generated payload being successfully validated, the operations can include executing the workflow as an automation-as-a-service workflow using the validated generated payload.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 illustrates a system for provisioning a workflow according to several aspects of the present disclosure.

FIG. 2 illustrates a method for executing a workflow according to several aspects of the present disclosure.

FIG. 3 illustrates yet another method according to several aspects of the present disclosure.

FIG. 4 illustrates a system according to several aspects of the present disclosure.

### DETAILED DESCRIPTION

While the illustrative embodiments are described herein for particular applications, the present disclosure is not limited thereto. Those skilled in the art and with access to the teachings provided herein will recognize additional applications, modifications, and embodiments within the scope thereof and additional fields in which the present disclosure would be of significant utility.

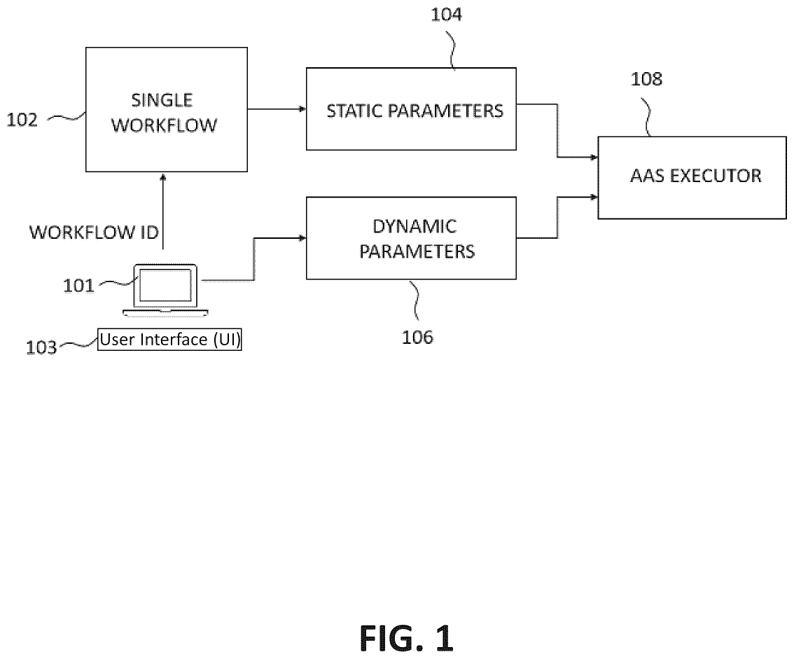

FIG. 1 illustrates an exemplary embodiment featuring a system 100 for provisioning a workflow according to several aspects of the teaching presented herein. The system 100 can be configured to simplify the execution of one or more AaaS workflows associated with a specified environment, each of which may be assigned a workflow identifier upon creation. The system 100 can include a device 101 including a user interface (UI) 103.

The device 101 may be an application-specific processor communicatively coupled to a memory that includes instructions that configure it to perform certain operations. For example, the device 101 may be configured to create a skeleton workflow 102 including single static workflow parameters. The skeleton workflow 102 can include all the steps, conditional blocks, and parallel gateways necessary for execution. The device 101 may be further configured to extract a payload from the skeleton workflow 102 to create a set of static parameters 104. The extraction may be from a remote device, and it may be performed via a network console.

The set of static parameters 104 may include all the logic and static values of the skeleton workflow 102. These logic and static values may be common to one or more environments other than the specified environment. Further, the set of static parameters 104 may be configured, by example and not by limitation, as a JavaScript Object Notation (.JSON) file. Furthermore, the file may be subsequently indexed on a global file system and/or in a source code repository, each of which can be independently scanned and screened against SDLC requirements during future development tasks.

The device 101 may be further configured to create a set of dynamic parameters 106 associate with the specified environment. The set of dynamic parameters 106 may include all the execution level parameters specific to the specified environment or to an instance of the specified environment. For example, and not by limitation, the device 101 may be configured to create the set of dynamic parameters 106 as a .JSON file or it may be configured to provide a path to a .JSON file that includes the set of dynamic parameters 106.

Further, the set of dynamic parameters 106 may be formatted as a .JSON file that has a plurality of fields including identifiers, order number, index number, depth, and parameters that includes keys and their corresponding values. The set of dynamic parameters may be subsequently indexed on the global file system and/or in the source code repository, each of which can be independently scanned and screened against SDLC requirements during future development tasks.

The system 100 may further include an execution module 108 which may be a single execution point module that executes a provisioned workflow that contains both the set of static parameters 104 and the set of dynamic parameters 106, taking both of these sets as its input. The execution module 108 may be further configured to trigger the workflow with certain parameters, check the workflow's status recursively for a predetermined time and providing a status report in the form of a message or a log. The predetermined time may be, for example and not by limitation, five minutes.

The execution module 108 may be further configured to output a trigger status and execution correlation identifier. Furthermore, one of ordinary skill in the art will readily recognize that the execution module 108 may be an application-specific processor configured by instructions that impart to it a structure that cause it to perform the above-noted operation. The execution module 108 may be co-located with the device 101, or it may be another device communicatively coupled to the system 100.

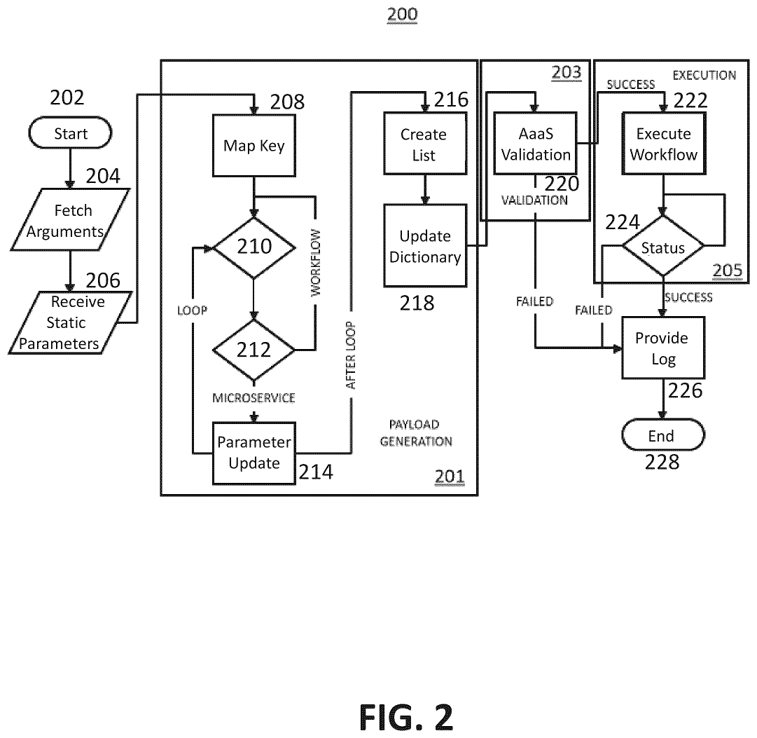

FIG. 2 illustrates an exemplary embodiment featuring a method 200 for executing a simplified AaaS workflow according to several teachings presented herein. The method 200 may be embodied as instructions residing in a non-transitory computer-readable medium, and the instructions can impart an application-specific structure to the processor, causing it to perform operations consistent with action blocks of the method 200 depicted in FIG. 2 and described herein after.

The method 200 begins at block 202 and ends at block 228. After starting, the method 200 includes, at block 204, fetching arguments, setting class variables, logging initial details or states relating to an environment and/or a workflow associated with an environment. The method 200 includes, at block 206, receiving a set of static parameters and a set of dynamic parameters, both sets being represented as a .JSON file, by example and not by limitation.

The method 200 further includes executing a module 201, which includes creating, at block 208, a mapping with a stepID as a Key and a payload as a value. The module 201 further includes a loop 210 which iterates over stepID to payload-map static parameters to create a workflow.

The loop includes a decision block 212 that determines whether the loop is a microservice or a workflow. In response to the block 212 being a microservice, the loop includes updating dynamic parameters in block 214 to map static parameters to a payload dictionary. In contrast, if the block 212 is a workflow, the loop returns to the block 210 to further iterate over the stepID. Upon exiting the loop, the module 201 further include a block 216 that includes creating a list containing values of the payload dictionary. The module 201 then further includes block 218 for updating the static parameters dictionary with those steps and other times such as “change control,” and “global hosts.” The module 201 then exits and the method 200 further includes a payload validation module 203.

In the module 203, the method 200 includes a block 220 wherein the generated payload from the module 201 is sent for validation with AaaS application program interface (API). If the validation is unsuccessful, the method 200 moves to block 226 that includes providing a log and transmitting a status message to a remote device, e.g., in the form of an electronic mail message, and the method 200 ends at block 228.

If the validation from the module 201 is successful, the method 200 moves to an execution module 205, including executing the AaaS workflow with the validated payload at block 222. The method 200 further includes, at block 224, determining the status of the AaaS workflow during execution, while it is queued, or while it is initiated. If the status check fails, the method 200 moves to the block 226 and ends at block 228. Otherwise, i.e., if the status check is successful, the method 200 includes creating a log and communicating the status of the execution at block 226, and the method 200 ends at block 228.

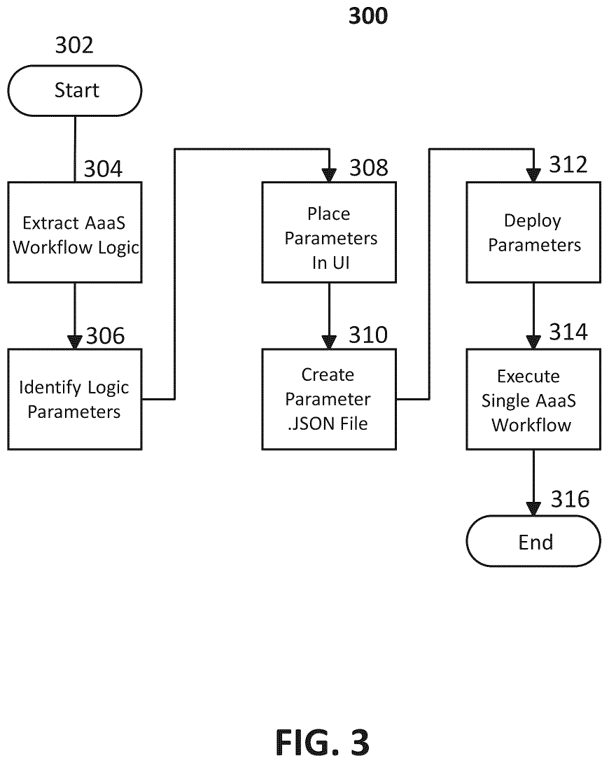

FIG. 3 illustrates an exemplary embodiment that features a method 300 according to several aspects of the teachings presented herein. The method 300 may be a use case of the above-noted system and corresponding method. The method 300 begins at block 302. At block 304, a device may retrieve or extract the structure and logic of an AaaS workflow. This may be achieved from a browser, by example and not by limitation.

At block 306, the method 300 includes identifying dynamic parameters, and at block 308, the method 300 includes placing the dynamic parameters in an AaaS UI. The method 300 includes, at block 310, creating a dynamic parameter .JSON file and, at block 312, the method 300 includes deploying static and dynamic parameter files in a global file system and/or a source code repository. The method 300 then includes, at block 314, executing the single AaaS workflow at a single point of execution during the activity. The method 300 ends at block 316.

Generally the systems and methods described herein may, in a use case, instruct a device to perform the following action blocks to preserve the state of an environment and execute a workflow with parameters for the environment. These blocks may include preserving the state which includes: (1) retrieving static parameters in .JSON format, from a browser for example, (2) identifying dynamic parameters, (3) creating dynamic parameters as a .JSON file, and (4) deploying the static and dynamic parameters in a global file system and/or a source code repository.

These blocks may further include executing the workflow with the parameters, by (5) updating a single workflow with the dynamic parameters' keys. For example, and not by limitation, the dynamic parameters' key may be rounded by “${ },” Ex: ${ENVIRONMENT}. The steps may further include (6) executing the workflow from a single microservice as an executor by providing the parameter file paths. A user can then monitor and very the status of the execution by consulting logs and transmissions of the system.

Furthermore, a UI like the UI 103 may be associated with the above-described systems and methods, and it may include a single-click platform that can be configured to build and maintained AaaS automated workflows. Such a platform may be powered by a variety of inventory systems known of those of skill in the art. It may support a plurality of user roles, including a public user, a site reliability engineering (SRE), and that of a platform administrator. Each type of role is associated with a set of permissions. For example, and not by limitation, a public persona may only have read-only privileges. An SRE persona may have read-only, creation of workflow execution, and management of workflow execution privileges, and no other privileges. A platform administrator persona may have all the privileges, e.g., read-only, registration of workflow templates, management of workflow templates, as well as creation and management of workflow executions.

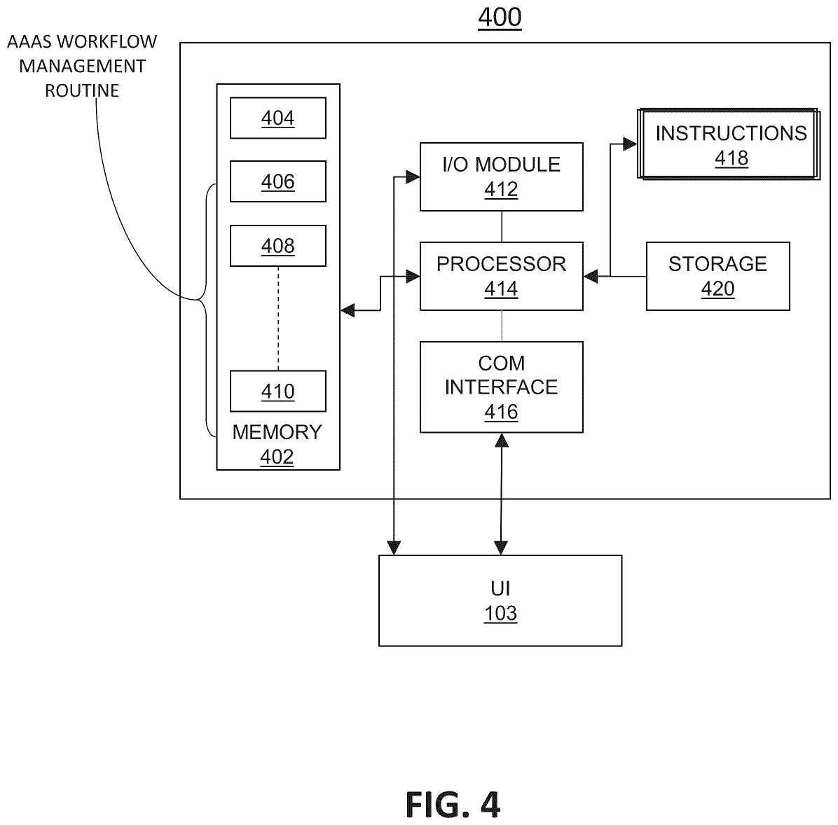

FIG. 4 illustrates a system 400 that may be an application-specific hardware, software, and firmware implementation of the system 100 as it configured to execute the methods described herein. The system 400 can include a processor 414 configured to executed one or more, or all of the steps of the method 200, the method 300, or the functions of the system 100 as described above. The processor 414 can have a specific structure. The specific structure can be imparted to the processor 414 by instructions stored in a memory 402 and/or by instructions 418 fetchable by the processor 414 from a storage medium 420. The storage medium 420 may be co-located with the system 400 as shown, or it can be remote and communicatively coupled to the system 400. Such communications can be encrypted.

The system 400 can be a stand-alone programmable system, or a programmable module included in a larger system. For example, the system 400 can be included in an AaaS workflow management infrastructure. The system 400 may include one or more hardware and/or software components configured to fetch, decode, execute, store, analyze, distribute, evaluate, and/or categorize information.

The processor 414 may include one or more processing devices or cores (not shown). In some embodiments, the processor 414 may be a plurality of processors, each having either one or more cores. The processor 414 can execute instructions fetched from the memory 402, i.e., from one of memory modules 404, 406, 408, or 410. Alternatively, the instructions can be fetched from the storage medium 420, or from a remote device connected to the system 400 via a communication interface 416. An input/output (I/O) module 412 may be configured for additional communications to or from remote systems or to the UI 103.

Without loss of generality, the storage medium 420 and/or the memory 402 can include a volatile or non-volatile, magnetic, semiconductor, tape, optical, removable, non-removable, read-only, random-access, or any type of non-transitory computer-readable computer medium. The storage medium 420 and/or the memory 402 may include programs and/or other information usable by processor 414, such as for example, instructions that embody the processor 414 to execute the method 200 or the method 300. Furthermore, the storage medium 420 can be configured to log data processed, recorded, or collected during the operation of the system 400.

The data may be time-stamped, location-stamped, cataloged, indexed, encrypted, and/or organized in a variety of ways consistent with data storage practice. By way of example, the memory modules 406 to 410 can form instructions that embody the method 200 or the method 300. The instructions embodied in these memory modules can cause the processor 414 to perform certain operations consistent with AaaS workflow management for a specified environment. For instance, the operations can include configuring a first set of parameters associated with one or more environments other than the specified environment. The operations may further include configuring set of parameters associated with the specified environment, and they may further include executing an automation service based on the first and second sets of parameters.

The first set of parameters may be a set of static parameters, and it may include logic and static values common to the one or more environments. The set of second parameters may be a set of dynamic parameters which are associated with and are particular to the specified environment. The second set of parameters can include execution level parameters specific to the specified environment. The first set of parameters and the second set of parameters may be combined as a single workflow during execution.

The operations may further include outputting a trigger status by the automation service and may include checking a status of the single workflow. Checking the status may be achieved recursively, and the checking may be performed for a predetermined amount of time. Furthermore, the automation service may be a single execution point service. Without limitation, but by example, the first set of parameters or the second set of parameters may be formatted as a JSON file. The automation service may be configured to provide a log, either before, during, or after execution.

Having described aspects of several particular embodiments, the teachings presented herein are now described in terms of several general embodiments. For instance, there is provided a method for configuring a workflow to create or manage a specified environment. The method may be embodied as instructions residing a non-transitory computer-readable medium, and these instructions may be configured to configure a processor to perform certain operations. As configured, the processor embodies an application-specific computing system configured in structure and function to conduct the operations which may include configuring a first set of parameters associated with one or more environments other than the specified environment. The operations may further include configuring set of parameters associated with the specified environment, and they may further include executing an automation service based on the first and second sets of parameters.

The first set of parameters may be a set of static parameters, and it may include logic and static values common to the one or more environments. The set of second parameters may be a set of dynamic parameters which are associated with and are particular to the specified environment. The second set of parameters can include execution level parameters specific to the specified environment. The first set of parameters and the second set of parameters may be combined as a single workflow during execution.

The operations may further include outputting a trigger status by the automation service and may include checking a status of the single workflow. Checking the status may be achieved recursively, and the checking may be performed for a predetermined amount of time. Furthermore, the automation service may be a single execution point service. Without limitation, but by example, the first set of parameters or the second set of parameters may be formatted as a JSON file. The automation service may be configured to provide a log, either before, during, or after execution.

In yet another exemplary embodiment, there is provided a system for configuring a workflow to create or manage a specified environment. The system can include a memory and a processor, which, when executing instructions from the memory, is configured to perform certain operations. The operations may include configuring a first set of parameters associated with one or more environments other than the specified environment, and they may include configuring a second set of parameters associated with the specified environment. The operations may further include executing an automation service based on the first and second sets of parameters.

In the exemplary system, the first set of parameters can be a set of static parameters that includes logic and static values common to one or more environments. The second set of parameters may be a set of dynamic parameters that includes execution level parameters specific to the specified environment. Furthermore, the first set of parameters and the second set of parameters are combined as a single workflow during the execution by the automation service. Moreover, the operations can include outputting a trigger status or checking a status of the single workflow. Checking may further be achieved as described above in the case of the exemplary method.

In yet another exemplary embodiment, there is provided a method for configuring a workflow to create or manage a specified environment. The method may be embodied as instructions residing on a non-transitory computer-readable medium. The instructions may be configured to cause a processor to perform certain operations. The operations can include receiving an input including a first set of parameters associated with one or more environments other than the specified environment and a second set of parameters associated with the specified environment. The operations can further include generating a payload based on the input and validating the generated payload. Furthermore, in response to the generated payload being successfully validated, the operations may include executing the workflow as an automation-as-a-service workflow using the validated generated payload.

Receiving the input may further include reading arguments, setting class variables, and logging an initial states or initial details. The operations can further include creating a log upon the generated payload being unsuccessfully validated and/or upon executing the workflow. The log may be transmitted to a remote device, for example, and not by limitation, via electronic mail. Furthermore, executing the workflow can include checking a status of execution and returning a message indicating the status of execution.

In yet another exemplary embodiment, there is provided a method for configuring a workflow to create or manage a specified environment. The method may be embodied as instructions residing on a non-transitory computer-readable medium where the instructions are configured to cause a processor to perform certain operations. The operations can include receiving an input including a first set of parameters associated with one or more environments other than the specified environment and a second set of parameters associated with the specified environment. The operations can further include generating a payload based on the input, which may include creating a loop including a mapping with a first as a key (stepID) and a payload dictionary for step as a value.

The operations can further include iterating over the first indicator (i.e., over the stepID) to payload map static parameters from the first set of parameters in the payload dictionary. The operations can further include determining whether a current step is a microservice or a workflow, and further iterating over the first indicator when the current step is a workflow and updating dynamic parameters from the second set of parameters into the payload dictionary when the current step is a microservice. The operations can further include creating a list containing values from the payload dictionary. Furthermore, the operations can further include updating static parameters of the dictionary with parameters from the first set of parameters.

In yet another exemplary embodiment, there is provided a system for configuring a workflow to create or manage a specified environment. The system includes a memory and a processor, which when executing instructions from the memory, is configured to perform certain operations. The operations can include receiving an input including a first set of parameters associated with one or more environments other than the specified environment and a second set of parameters associated with the specified environment. The operations can further include generating a payload based on the input and validating the generated payload. Furthermore, in response to the generated payload being successfully validated, the operations can include executing the workflow as an automation-as-a-service workflow using the validated generated payload.

The operations can include reading arguments, setting class variables, and logging an initial state or initial details to construct the input. The operations can include creating a log upon the generated payload being unsuccessfully validated and/or upon executing the workflow. The operations can further include transmitting the log to a remote device. Furthermore, upon executing the workflow, the operations can include checking a status of execution and returning a message indicating the status of execution. And, the automation-as-a-service workflow may be a single execution point service, and the first set of parameters and/or the second set of parameters may be formatted as JSON files.

Those skilled in the relevant art(s) will appreciate that various adaptations and modifications of the embodiments described above can be configured without departing from the scope and spirit of the disclosure. Therefore, it is to be understood that, within the scope of the appended claims, the disclosure may be practiced other than as specifically described herein.

What is claimed is:

1. A method for configuring a workflow to create or manage a specified environment, the method residing as instructions on a non-transitory computer-readable medium, the instructions being configured to cause a processor to perform operations including:
receiving an input including a first set of parameters associated with one or more environments other than the specified environment and a second set of parameters associated with the specified environment;
generating a payload based on the input;
validating the generated payload, and
executing, in response to the generated payload being successfully validated, the workflow as an automation-as-a-service workflow using the validated generated payload.

2. The method of claim 1, wherein the receiving further includes at least one of (i) reading arguments, (ii) setting class variables, and (iii) logging an initial state.

3. The method claim 1, wherein the operations further includes creating a log upon the generated payload being unsuccessfully validated.

4. The method of claim 1, wherein the operations further include creating a log upon executing the workflow.

5. The method of claim 3, wherein the operations further include transmitting the log to a remote device.

6. The method of claim 4, wherein the operations further include transmitting the log to a remote device.

7. The method of claim 1, wherein executing the workflow includes checking a status of execution and returning a message indicating the status of execution.

8. A method for configuring a workflow to create or manage a specified environment, the method residing as instructions on a non-transitory computer-readable medium, the instructions being configured to cause a processor to perform operations including:
receiving an input including a first set of parameters associated with one or more environments other than the specified environment and a second set of parameters associated with the specified environment;
generating a payload based on the input, the generating including:
creating a loop including a mapping with a first as a key and a payload dictionary for step as a value;
iterating over the first indicator to payload map static parameters from the first set of parameters in the payload dictionary; and
determining whether a current step is a microservice or a workflow, and further iterating over the first indicator when the current step is a workflow and updating dynamic parameters from the second set of parameters into the payload dictionary when the current step is a microservice.

9. The method of claim 8, wherein the operations further include creating a list containing values from the payload dictionary.

10. The method of claim 8, wherein the operations further include updating static parameters of the dictionary with parameters from the first set of parameters.

11. A system for configuring a workflow to create or manage a specified environment, the system comprising:
a memory;
a processor, which when executing instructions from the memory, is configured to perform operations including:
receiving an input including a first set of parameters associated with one or more environments other than the specified environment and a second set of parameters associated with the specified environment;
generating a payload based on the input;
validating the generated payload, and
executing, in response to the generated payload being successfully validated, the workflow as an automation-as-a-service workflow using the validated generated payload.

12. The system of claim 11, wherein the receiving further includes at least one of (i) reading arguments, (ii) setting class variables, and (iii) logging an initial state.

13. The system of claim 11, wherein the operations further include creating a log upon the generated payload being unsuccessfully validated.

14. The system of claim 11, wherein the operations further include creating a log upon executing the workflow.

15. The system of claim 13, wherein the operations further include transmitting the log to a remote device.

16. The system of claim 14, wherein the operations further include transmitting the log to a remote device.

17. The system of claim 11, wherein executing the workflow includes checking a status of execution and returning a message indicating the status of execution.

18. The system of claim 11, wherein the automation-as-a-service workflow is a single execution point service.

19. The system of claim 11, wherein the first set of parameters or the second set of parameters is formatted as a JSON file.

20. The system of claim 15, where transmitting the log is achieved via electronic mail.
